(19) United States
(12) Patent Application Publication
(10) Pub. No.: US 2009/0268169 A1
(43) Pub. Date: Oct. 29, 2009

(54) Overhead projection screen

(76) Inventors: Arno Schubert, Chevaigne (FR); Pascal Benoit, Liffre (FR); Khaled Sarayeddine, Nouvoitou (FR)

Correspondence Address: Thomson Licensing LLC, P.O. Box 5312, Two Independence Way, PRINCETON, NJ, 08543-5312, US

(21) Appl. No.: 10/585,653

(22) PCT Filed: Jan. 7, 2005
(86) PCT No.: PCT/EP2005/050053

§ 371 Date: Jul. 7, 2006

(30) Foreign Application Priority Data
Jan. 7, 2004 (FR) 04500258

(51) Int. Cl. G03B 21/60; G02B 5/32

(52) U.S. Cl. 353/38; 359/454; 359/15

(57) ABSTRACT

An optical plate, in particular in a screen for projection display device, comprises, on a first side, optical elements designed to bend rays received from a light source into a beam of rays in a first direction in a plane containing a main axis. The second side is produced in such a way as to bend the beam in a second direction that is different from the first direction, preferably in line with the main axis.

### FIELD OF THE INVENTION

The invention relates to an optical plate and a projection display device using such a plate.

### TECHNOLOGICAL BACKGROUND

The use in optical technology of a Fresnel lens to obtain a general collimation effect with a reduced lens thickness is well known. Thus, in order to collimate an incident beam sent by a light source, the lens comprises prismatic elements that bend the rays received from the source into a beam of parallel rays.

As is disclosed in the patent application published under the reference JP 2002-221 605, the prismatic elements are designed to bend the incident rays either by refraction (low angle of incidence), or by reflection (high angle of incidence).

Such lenses are, for example, used in a projection display device. In practice, in such a device, a small imager is projected onto a display screen by a projection system, with angles of incidence on the screen that extend over a determined range of values, for example from 30° to 60°.

The flow received from the projection system must therefore be globally collimated by a Fresnel lens, that is bent in a horizontal direction, before being generally micro-focused through a dark matrix then diffused in the desired observation field.

The optical effectiveness (or efficiency) of the prismatic elements of the Fresnel lens is, however, mediocre for certain incidences, and in particular for angles of incidence of 20° to 40°. In practice, such angles do not allow a good efficiency either by reflection or by refraction for prismatic structures located on the incident side.

### SUMMARY OF THE INVENTION

In order in particular to resolve this problem, the invention proposes to use, in place of the Fresnel lens, an optical plate comprising on a first side a first set of at least two optical elements designed to bend rays received from a light source into a beam of rays that are essentially parallel to a first direction in a plane containing a main axis, with means on the second side to bend said beam in a second direction different from the first direction.

According to one possible solution, the second side bears at least one first optical element to bend the beam in the second direction. In this case, the first optical element preferably comprises at least one side having an orientation such that the rays in the first direction are refracted in the second direction.

Advantageously, the second side can then bear a second optical element having a side that is essentially parallel to said side of the first optical element in said plane.

According to another possible solution, the second side includes a holographic device to bend the beam in the second direction.

Generally, the optical elements preferably have symmetry of revolution about the main axis and the second direction is directed essentially in line with the main axis.

In a first embodiment, the optical elements are designed to bend the rays from the source by refraction. In a second embodiment, the optical elements each include a side designed to reflect the rays from the source in the first direction.

According to a preferred characteristic, the essentially parallel rays form an angle less than or equal to 3° with the first direction.

Advantageously, said first direction forms an angle greater than or equal to 10° with said second direction.

The invention proposes to use the optical plate in a screen of a projection display device also comprising means of generating an image and means of projecting the image onto the screen. The screen can also comprise optical focus and/or diffusion elements.

According to a particularly advantageous construction, the projection means are such that the rays are received by the optical plate with angles of incidence relative to the general direction of the optical plate varying over a continuous range of non-zero orientations relative to the main axis and the first direction corresponds to one of the orientations of said continuous range.

### LIST OF FIGURES

Other characteristics of the invention will become apparent in light of the description that follows, given with reference to the appended drawings in which:

FIG. 1 represents an exemplary display device to which the invention applies;

FIG. 2 represents the screen of FIG. 1, using a first embodiment of the invention;

FIG. 3 represents a detail of FIG. 2;

FIG. 4 represents the screen of FIG. 1 using a second embodiment of the invention;

FIG. 5 represents a detail of FIG. 4.

### DETAILED DESCRIPTION OF THE INVENTION

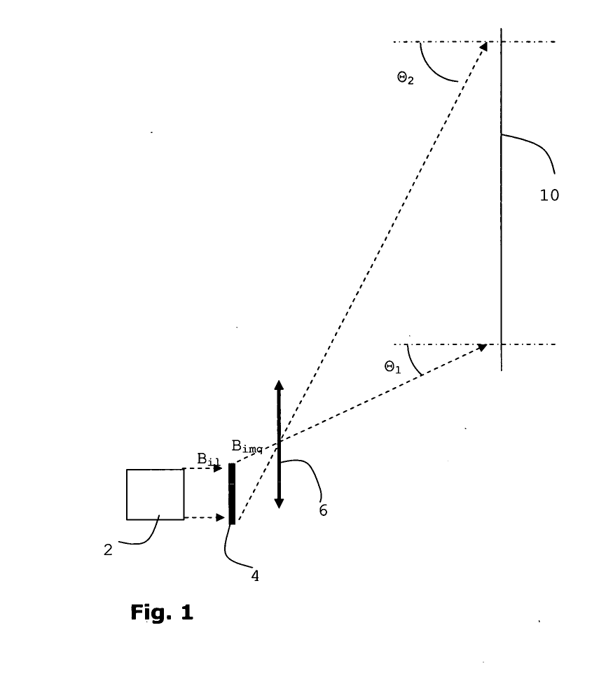

The display device diagrammatically represented in FIG. 1 comprises a lighting system 2 which generates a primary light beam Bᵢₗₗ received by an imager (or valve) 4.

The imager 4 determines which parts of the primary beam Bᵢₗₗ must be transmitted to an imaging system, so creating a beam of secondary light B_{img} which represents the image to be displayed.

The imager 4 is, for example, produced in the form of a matrix of pixels. Each pixel acts on the incident ray (part of the primary beam Bᵢₗₗ) according to the intensity with which the corresponding pixel in the image to be displayed must be lit.

The light from the imager 4 is projected by an imaging system 6 towards a display screen 10.

In the example represented in FIG. 1, the incident rays on the screen 10 have an angle of incidence that varies from an angle Θ₁ (approximately 10°) in its bottom part to an angle Θ₂ (approximately 60°) in its top part.

In the description that follows, the term “optical engine” is used to designate the set of elements that generates the beam intended for the screen 10, namely, in this case, the assembly comprising the lighting system 2, the imager 4 and the imaging system 6.

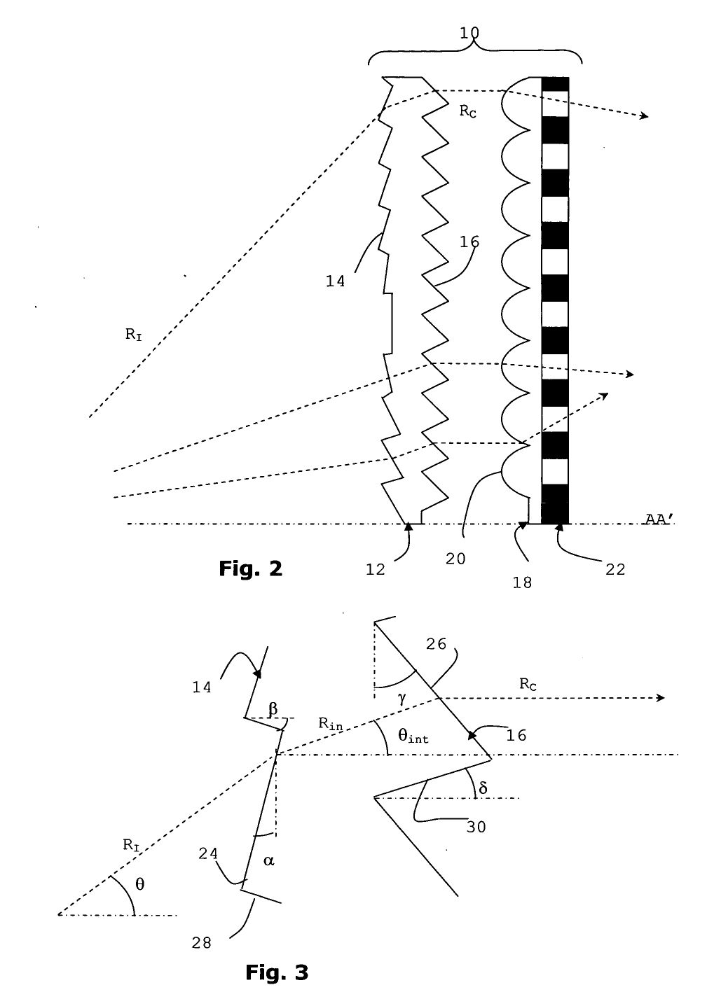

A first embodiment of the screen 10 according to the invention is represented in FIG. 2.

The screen 10 comprises an optical plate 12, the function of which is to collimate the incident beam R_{I} into a beam R_{C} that is essentially parallel to a main axis AA′. (Normally, the main axis AA′ is horizontal and perpendicular to the plane defined by the optical plate 12.)

To do this, the optical plate 12 comprises on its first side (the side that receives the light from the source, in this case, namely, the optical engine) first prismatic elements 14 and, on its second side (output side of the light, therefore directed towards the abovementioned focus elements), second prismatic elements 16.

The optical plate 12 has symmetry of revolution about the main axis AA′ (output axis of the optical engine) and FIG. 2 represents a section along a plane containing the main axis AA′, in this case the vertical plane containing the main axis AA′.

In each plane containing the main axis AA′, the first prismatic elements 14 bend the incident beam R_{I} into a beam that is overall parallel to a first direction Rᵢₙₜ different from the direction of the main axis AA′. (The direction Rᵢₙₜ therefore depends on the plane containing the main axis concerned.)

Thus, whatever the angle of incidence θ on the first prismatic element 14 (that is, whatever the height of the first prismatic element 14 on the plate 12), the incident ray R_{I} is refracted in a ray Rᵢₙₜ that forms with the main axis AA′ a fixed angle θᵢₙₜ, as will be explained in detail below with reference to FIG. 3. According to an embodiment variant, given production uncertainties, the angle θᵢₙₜ can vary according to an amplitude of 3° (θᵢₙₜ is equal to a fixed value plus or minus 3°).

The second prismatic elements 16 are therefore designed such that they bend the beam Rᵢₙₜ essentially parallel (that is, preferably parallel to a direction determined with an uncertainty of plus or minus 3°, the beam Rᵢₙₜ being inside the material of the optical plate) (in each plane containing the main axis AA′) into a beam R_{C} in a second direction that is essentially parallel to the main axis AA! (that is, preferably, parallel to the main axis with an uncertainty of plus or minus 5°, the beam R_{C} being outside the material of the optical plate). The second prismatic elements are therefore identical whatever the height on the plate 12 (that is, whatever the distance of the main axis AA′ from the second prismatic element 16 concerned). Preferably, the angle between the first direction and the second direction is greater than or equal to 10° and even more preferably, 15°.

The collimated beam R_{C} at the output of the optical plate 12 falls on a set 18 of focus elements 20 that enable the beam to pass through a dark matrix 22, which improves the contrast. The focus elements 20 also normally allow the beam to be diffused vertically and horizontally in order to project the images in an adequate solid angle.

Other optical elements can, of course, be provided to modify the optical characteristics of the beam, for example in the dark matrix 22.

The detail of first and second prismatic elements 14, 16 is given in FIG. 3 in cross section in the vertical plane containing the main axis AA′.

The first prismatic element 14 comprises a first optically active side 24 which forms an angle α with the general direction of the plate 18, that is, in this case, with the vertical. As previously described, an incident ray R_{I} on the optical plate 12 with an angle θ (angle formed with the main axis AA′) will be refracted by the first side 24 inside the optical plate 12 in the form of a ray Rᵢₙₜ in a first direction that forms with the main axis an angle θᵢₙₜ that is fixed, and therefore in particular independent of θ.

According to the laws of refraction, for an optical plate of index n, the following therefore applies:

sin(θ−α)=n.sin(θᵢₙₜ−α)

which can be developed as follows:

$$α = a tan ( \frac{n \cdot sin {θ}_{int} - sin θ}{s \cdot cos {θ}_{int} - cos θ} ) .$$

Preferably, θᵢₙₜ is chosen such that the effective angle of incidence (θ−α) on the first side 24 remains low over all of the plate to obtain a good refraction efficiency of the first elements 14. Such is in particular the case when θᵢₙₜ is chosen from the range of the angles of incidence, that is, between Θ₁ and Θ₂, for example θᵢₙₜ=½.(Θ₁+Θ₂).

The second side 28 of the first prismatic element 14, which forms an angle β with the direction of the main axis AA′, is not optically active, and must therefore intercept the fewest possible light rays.

In the part where θ is less than θᵢₙₜ, β is preferably taken to be close to θ and/or θᵢₙₜ (to avoid the interception of rays by the side 28 inside or outside the optical plate 12). Naturally, β is not necessarily constant on the plate 12; it is possible to take, for example, for each first prismatic element 14: β=θ. An alternative solution is to use for all the prisms concerned, precisely β=θᵢₙₜ. These solutions are in particular interesting in the case mentioned above (θᵢₙₜ between Θ₁ and Θ₂) where θ is close to θᵢₙₜ over all the height of the plate 12. For the part where θ is greater than θᵢₙₜ, the side 28 is, for example, taken according to AA′ (β=3°).

The second prismatic element 16 comprises a first optically active side 26 which forms an angle γ with the general direction of the plate 12 (in this case, with the vertical). As seen previously, the second prismatic element 16, and therefore its first side 26, bends by refraction the beam Rᵢₙₜ internal to the plate directed in the first direction into a collimated beam R_{C} in a second direction that is essentially parallel to the main axis AA′ (that is, preferably, parallel to the main axis with an uncertainty of plus or minus 5°, the beam R_{C} being outside the material of the optical plate). Preferably, the angle between the first direction and the second direction is greater than or equal to 10°.

According to the laws of refraction, the following therefore applies:

sin γ=n.sin(γ−θᵢₙₜ)

and γ is thus defined by:

$$γ = a tan ( \frac{n \cdot sin {θ}_{int}}{n \cdot cos {θ}_{int} - 1} ) .$$

It can be seen that, although the first direction Rᵢₙₜ is constant only in each plane containing the main axis AA′, the second direction R_{C} is directed in line with the main axis AA′ and therefore constant in all the planes containing this axis, that is, over all the plate.

The second side 30 of the second prismatic element 16 is not optically active and is therefore determined so as to obtain prisms that are the least acute possible to facilitate their production, for example by forming an angle δ with the main axis AA′ that is close to, even equal to, θᵢₙₜ.

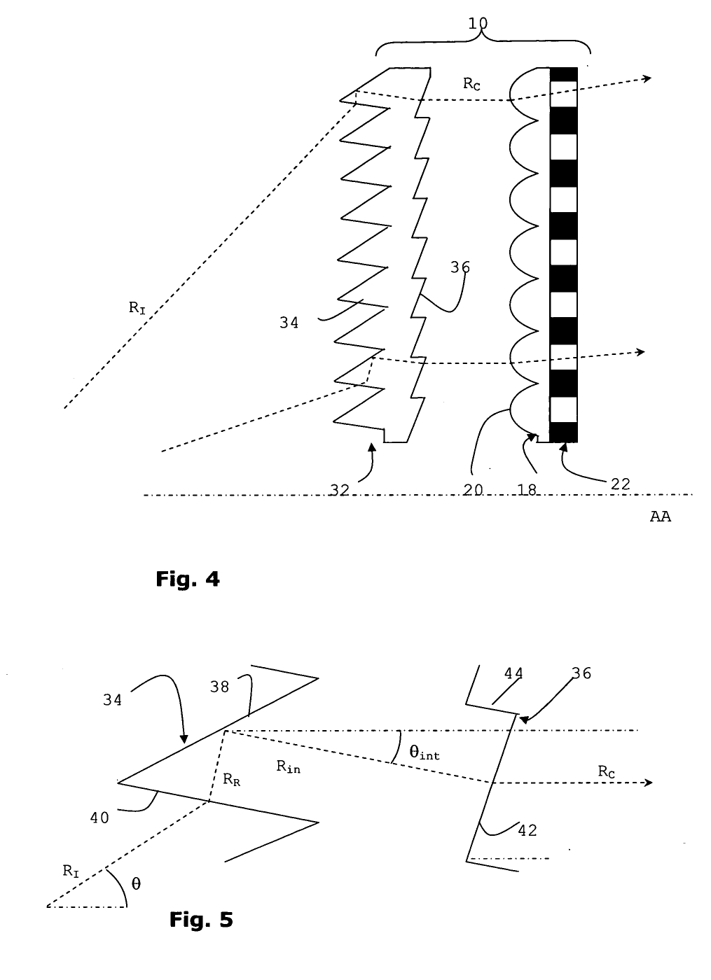

A second embodiment of the screen 10 is represented in FIG. 4. In this figure, the elements that are identical to those present in the first embodiment (FIG. 2) bear the same references and will not be described again.

The screen 10 in this case also comprises an optical plate 32, the function of which is to collimate the incident beam R_{I} into a beam R_{C} essentially parallel to the main axis AA′.

As in the first embodiment, and to this end, the optical plate 32 comprises, on its first side, first prismatic elements 34 and, on its second side, second prismatic elements 36.

The optical plate 32 also has symmetry of revolution about the main axis AA′ (output axis of the optical engine) and FIG. 4 represents a section along a plane containing the main axis AA′, in this case the vertical plane containing the main axis AA′.

As for the first embodiment, the first prismatic elements 34 bend, in each plane containing the main axis AA′, the incident beam R_{I} into a beam that is overall parallel to a first direction Rᵢₙₜ (that is, preferably, parallel to a direction determined with an uncertainty of plus or minus 3°, the beam Rᵢₙₜ being inside the material of the optical plate) different from the direction of the main axis AA′. (The direction Rᵢₙₜ therefore depends on the plane containing the main axis concerned.) Preferably, the angle between the first direction and the direction of the main axis is greater than or equal to 10°.

Thus, whatever the angle of incidence θ on the first prismatic element 34 (that is, whatever the height of the first prismatic element 34 on the plate 32), the incident ray R_{I} is refracted then reflected in a ray Rᵢₙₜ which forms with the main axis AA′ a fixed angle θᵢₙₜ, in this case negative, as will be explained in detail below with reference to FIG. 5.

The second prismatic elements 36 are therefore designed such that they bend the essentially parallel beam Rᵢₙₜ (in each plane containing the main axis AA′) into a beam R_{C} in a second direction that is essentially parallel to the main axis AA′ (that is, preferably parallel to the main axis with an uncertainty of plus or minus 5°, the beam R_{C} being outside the material of the optical plate). The second prismatic elements are therefore identical whatever the height on the plate 32 (that is, whatever the distance of the main axis AA′ from the second prismatic element 36 considered).

The detail of first and second prismatic elements 34, 36 is given in FIG. 5 in cross section in the vertical plane containing the main axis AA′.

The first prismatic element 34 comprises a first side 38 and a second side 40. An incident ray R_{I} on the optical plate 12 with an angle θ (angle formed with the main axis AA′) is refracted by the second side 40 inside the optical plate 12 in the form of a ray R_{R} directed towards the first side 38; the first side 38 reflects this ray R_{R} in a ray Rᵢₙₜ in a first direction that forms with the main axis an angle θᵢₙₜ that is non-zero and fixed, and therefore in particular independent of θ.

The second prismatic element 36 comprises a first optically active side 42 which forms a non-zero angle with the general direction of the plate 12 (in this case with the vertical). As seen previously, the second prismatic element 36, and therefore its first side 42, bends by refraction the beam Rᵢₙₜ internal to the plate directed in the first direction into a collimated beam R_{C} in a second direction that is essentially parallel to the main axis AA′.

The second side 44 of the second prismatic element 36 is not optically active and is therefore determined in such a way as to obtain prisms that are the least acute possible to facilitate their production. The second side 44 is therefore preferably oriented parallel to the main axis AA′.

The invention is naturally not limited to the embodiments described above. In particular, the means of bending the internal beam Rᵢₙₜ into a collimated beam in line with the main axis can, for example, be produced by a holographic surface on the second side of the optical plate. The holographic structure in particular comprises a structure with pseudo-periodic variation of the optical index. This solution is, moreover, particularly advantageous because of the parallel alignment of the internal rays Rᵢₙₜ in the plate in each plane containing the main axis.

1. An optical plate (12; 32) comprising on a first side a first set of at least two optical elements (14; 34) designed to bend rays (R_{I}) received from a light source into a beam of rays (Rᵢₙₜ) that are essentially parallel to a first direction in a plane containing a main axis (AA′),
characterized by means (16; 36) on the second side to bend said beam in a second direction (R_{C}) different from the first direction (Rᵢₙₜ).

2. The optical plate as claimed in claim 1, in which the second side bears at least one first optical element (16; 36) to bend the beam in the second direction (R_{C}).

3. The optical plate as claimed in claim 2, in which the first optical element (16; 36) comprises at least one side (26; 42) having an orientation such that the rays in the first direction (Rᵢₙₜ) are refracted in the second direction (R_{C}).

4. The optical plate as claimed in claim 3, in which the second side bears a second optical element having a side that is essentially parallel to said side of the first optical element in said plane.

5. The optical plate as claimed in claim 1, in which the second side includes a holographic device to bend the beam in the second direction (R_{C}).

6. The optical plate as claimed in one of claims 1 to 5, in which the optical elements (14; 34) have symmetry of revolution about the main axis (AA′) and in which the second direction (R_{C}) is directed essentially in line with the main axis (AA′).

7. The optical plate as claimed in one of claims 1 to 6, in which the optical elements (14) are designed to bend the rays from the source by refraction.

8. The optical plate as claimed in one of claims 1 to 6, in which the optical elements (34) each include a side (38) designed to reflect the rays (R_{I}) from the source in the first direction (Rᵢₙₜ).

9. The optical plate as claimed in any one of claims 1 to 8, characterized in that the first set of at least two optical elements is designed to bend rays received from a light source into a beam of rays forming an angle less than or equal to 3° with the first direction.

10. The optical plate as claimed in any one of claims 1 to 9, characterized in that the second direction forms an angle greater than or equal to 10° with the first direction.

11. A projection display device comprising:
means of generating an image (2, 4);
means (6) of projecting the image onto a screen (10);
the screen (10) comprising at least one optical plate (12; 32),
in which the optical plate (12; 32) conforms to one of claims 1 to 8.

12. The display device as claimed in claim 11, in which the projection means (6) are such that the rays (R_{I}) are received by the optical plate (12) with orientations (θ) relative to the general direction of the optical plate (12) varying over a continuous range of non-zero orientations relative to the main axis (AA′) and in which the first direction (Rᵢₙₜ) corresponds to one (θᵢₙₜ) of the orientations of said continuous range.
